(19) United States
(12) Patent Application Publication
(10) Pub. No.: US 2004/0203962 A1
(43) Pub. Date: Oct. 14, 2004

(54) Wireless human interface and other attached device data encryption through bi-directional RF link

(76) Inventors: Drew J. Dutton, Austin, TX (US); James R. MacDonald, Buda, TX (US)

Correspondence Address: Jeffrey C. Hood, Meyertons, Hood, Kivlin,, Kowert & Goetzel PC, P.O. Box 398, Austin, TX, 78767, US

(21) Appl. No.: 10/409,950

(22) Filed: Apr. 9, 2003

(51) Int. Cl. H04Q 7/20

(52) U.S. Cl. 455/466

(57) ABSTRACT

A system and method for encoding and decoding radio frequency (RF) signals between a computer and an RF peripheral device. Because information communicated between a computer and an RF peripheral device may be sensitive, e.g., contain passwords or credit card numbers, RF signals may be encoded and decoded by the computer and/or RF peripheral device before transmission between the computer and RF peripheral device to preserve the security of the information. The computer may transmit a key register to the RF peripheral device that may be used to encode RF signals sent to the computer or decode RF signals received by the computer. The key registers may be changed as needed. The RF signals may contain encoded and unencoded sections.

### BACKGROUND OF THE INVENTION

1. Field of the Invention

The present invention relates generally to managing peripheral device usage for a computer system and specifically to data encryption for communication between a peripheral device and a computer system.

2. Description of the Related Art

Computer systems may use many different types of peripheral devices. For example, computer systems may receive input from user input devices such as, but not limited to, a pointing device, such as a computer mouse, a keyboard, a microphone, a camera, a gamepad, a touchscreen, and a joystick. Because managing wires from different user input devices may be cumbersome, the computer system may use wireless, e.g., radio frequency (RF), signals to communicate with the user input device. For example, an RF peripheral device may transmit an RF signal to a computer system to provide the computer system with a user's inputs (e.g., mouse movements, keyboard keys pressed, etc.). The RF peripheral device may also receive RF signals from the computer system.

While using RF signals may allow peripheral devices to communicate with the computer system without requiring wires, RF signals may have disadvantages. For example, the RF signals transmitted by the RF peripheral device may be received by multiple computer systems. For example, besides a user's computer system, another nearby computer system may also receive the RF signals. Sensitive data, such as, but not limited to, passwords and credit card numbers, may be transmitted as RF signals by a peripheral device, such as a keyboard transmitting a key combination pressed by the user. Multiple computer systems may have access to the information transmitted, and therefore the security of the user's information may be compromised.

### SUMMARY OF THE INVENTION

In one embodiment, information transmitted between a computer and an RF peripheral device may be encoded prior to transmission and decoded when received. For example, when a user of the RF peripheral device transmits sensitive information such as, but not limited to, account usemames, passwords, or financial data, from the RF peripheral device to the computer (e.g., by typing the information into an RF keyboard for use by the computer), the sensitive information may be encoded by the RF peripheral device prior to transmission. In one embodiment, information may also be encoded by the computer prior to transmission of the information to the RF peripheral device. Embodiments of the RF peripheral devices described herein may also include wireless output devices, such as RF speakers, RF displays, and RF printers, which receive the information to output to the user.

In one embodiment, the computer and the RF peripheral device may use a public key encryption scheme or a symmetric key encryption scheme to encode/decode the information. For example, a key register (i.e., an encryption key) may be sent to the RF peripheral device by the computer and used by the micro-controller in the RF peripheral device to encode/decode the information transmitted between the RF peripheral device and the computer. For example, the information may be encoded and sent in blocks (i.e., communication data payloads). In one embodiment, a triple data encryption standard (DES) engine may be used in a standard cipher feedback configuration where the key register is used as an initialization vector for encoding the information. In one embodiment, the information may be encoded by applying XOR to the information and the initialization vector. A result of the XOR is an encoded communication data payload containing the information to be transmitted. In one embodiment, prior encoded communication data payloads may be used as the initialization vectors for subsequent information to be encoded. In one embodiment, the encoded information may be transmitted from the RF peripheral device and remain encoded until delivered to a remote device or computer over a wired or second wireless network.

### BRIEF DESCRIPTION OF THE DRAWINGS

A better understanding of the present invention may be obtained when the following detailed description is considered in conjunction with the following drawings, in which:

FIG. 1 illustrates a computer with an RF peripheral device, according to one embodiment;

FIG. 2 illustrates a block diagram of the computer and the RF peripheral device, according to one embodiment;

FIG. 3 illustrates a block diagram of a cipher-engine encoding information for a micro-controller, according to one embodiment;

FIG. 4 illustrates a block diagram of a cipher-engine for decoding information for a micro-controller, according to one embodiment;

FIG. 5 is a flowchart of a method for encoding and decoding the RF signals between the computer and the RF peripheral device, according to one embodiment; and

FIG. 6 is a flowchart of a method for encoding and decoding a key combination typed into an RF keyboard and transmitted to the computer, according to one embodiment.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

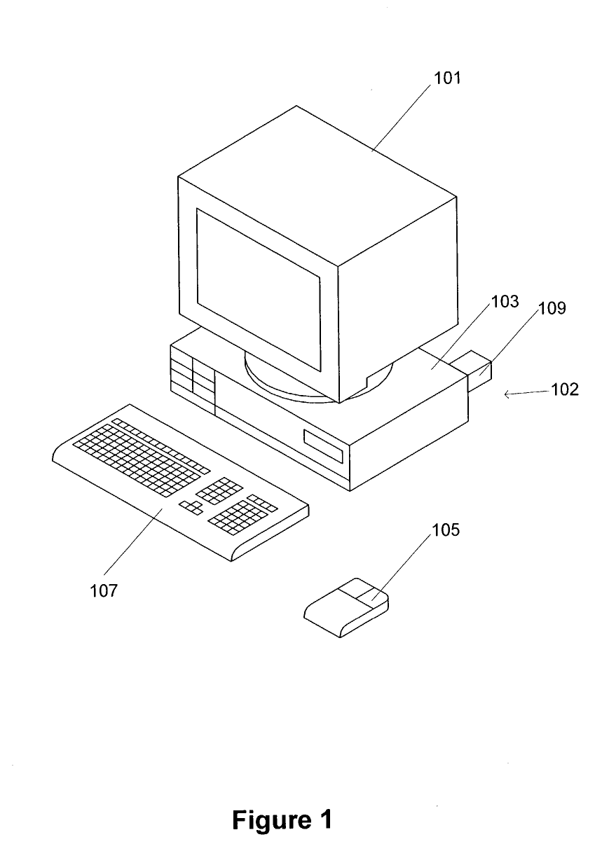

FIG. 1: Computer System with an RF Peripheral Device

FIG. 1 illustrates an embodiment of a computer system with a computer and an RF peripheral device. In various embodiments, the RF peripheral device may include a wireless input device such as, but not limited to, an RF pointing device, such as an RF computer mouse 105, an RF keyboard 107, an RF camera, an RF joystick, an RF gamepad, an RF touchscreen, or an RF microphone. Embodiments of the RF peripheral devices described herein may also be used with wireless output devices, such as an RF speaker, an RF display 101, and/or an RF printer. Other RF peripheral devices are also contemplated. In one embodiment, a computer 102 may have a processor/memory housing 103. In one embodiment, the computer 102 may communicate with the RF peripheral device through a peripheral base station 109 coupled to the processor/memory housing 103.

In one embodiment, RF signals may be transmitted between the computer 102 and the RF peripheral devices communicably coupled to the computer 102. For example, RF computer mouse movements may be transmitted to the computer 102 to control a cursor and keystrokes may be transmitted from the RF keyboard 107 to the computer 102 to provide user typed characters. Other input is also contemplated. As another example, output may be transmitted to the RF display 101 to display an image on the RF display 101. In one embodiment, the computer 102 may communicate with multiple RF peripheral devices on one channel. For example, adjacent computers may each use a separate channel to communicate with the respective computer's RF peripheral devices. Other channel usage is also contemplated. In one embodiment, the RF peripheral device may communicate with the computer 102 through a bit stream relayed half-duplex communication using a frequency shift keying (FSK) RF link. Other communication forms are also contemplated.

In one embodiment, sensitive information such as, but not limited to, account usernames, passwords, or financial data, may be transmitted between the RF peripheral device and the computer. One or both of the RF peripheral device and/or the computer system may operate to encode sensitive information, or all information, that is transmitted to the other. For example, a user may type a password into the RF keyboard 107 which may in turn transmit an encoded communication data payload containing the password to the computer. Transmission of other information is also contemplated.

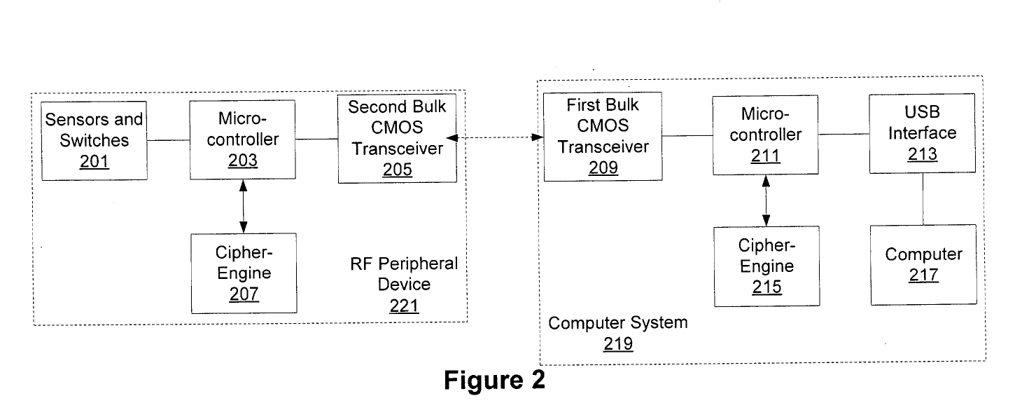

FIG. 2: Block Diagram of a Computer System and an RF Peripheral Device

FIG. 2 illustrates a block diagram of an embodiment of a computer system with an RF peripheral device. The computer system 219 may comprise a computer 217 coupled to a micro-controller 211 through a universal serial bus (USB) interface 213. In one embodiment, the micro-controller 211 may have a micro-processor and a first memory with instructions executable by the micro-processor. In one embodiment, a processor, such as a central processing unit (CPU), and the first memory, such as, but not limited to, a random access memory (RAM) or hard disk memory, may be used in place of the micro-controller 211. Other processors and other memories are also contemplated. The first memory may have instructions executable by the micro-processor to control a first radio frequency transmitter/receiver (RFTR) such as, but not limited to, a first bulk complementary metal oxide semiconductor (CMOS) transceiver 209. The first memory may also have program instructions executable to implement a cipher-engine 215 (or encoding engine). In one embodiment, the first RFTR and the micro-controller 211 may be located in the peripheral base station 109 (see FIG. 1) coupled to the computer 217 and use modulation and demodulation of RF signals for communication. In one embodiment, the first RFTR and the micro-controller 211 may be located in the processor/memory housing 103.

Also, as seen in FIG. 2, in one embodiment, the micro-controller 211 may use a cipher-engine 215 (or encoding engine) to encode information sent to the RF peripheral device 221. As used herein, “cipher-engine” may refer to a separate device coupled to the micro-controller 209, or may be implemented by executing instructions in the micro-controller 211, to code/decode information. Other embodiments of the cipher-engine are also contemplated.

In one embodiment, the RF peripheral device 221 may have a second RFTR such as, but not limited to, a bulk CMOS transceiver 205 for receiving and transmitting configuration information to the first bulk CMOS transceiver 209 coupled to the computer 217. The second RFTR may be coupled to a micro-controller 203. In one embodiment, the micro-controller 203 may have a micro-processor and a second memory with instructions executable by the micro-processor. In one embodiment, the micro-controller 203 may use a cipher engine 207. As discussed above, the cipher engine 207 may be a device separate from the micro-controller 203 or may be implemented using software in the micro-controller 203. The RF peripheral device 221 may use various sensors and switches 201 to gather information from the user for transmitting to the computer 217. For example, an RF computer mouse may have an X direction sensor and a Y direction sensor for detecting user input movement. Other sensors and switches are also contemplated. In addition, while the block diagram shows an embodiment with sensors and switches 201, other sources for inputs and outputs are also contemplated. For example, the computer 217 may send output information to an RF speaker. In one embodiment, the RF speaker may be designed to relay output information to the user only (e.g. through the use of wireless headphones). In one embodiment, the computer 217 may send the output information to the RF speaker in encoded form to prevent other computers from intercepting and interpreting the output information.

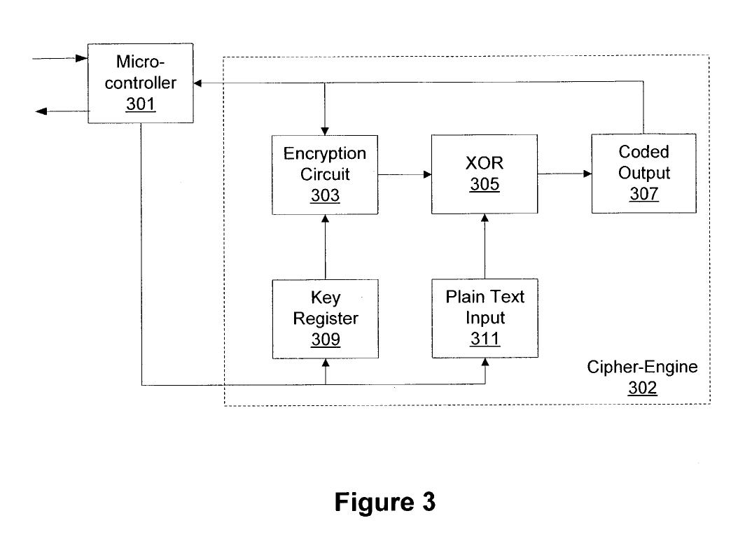

FIG. 3: Block Diagram for Encoding an RF Signal

FIG. 3 is a block diagram of an embodiment of a cipher-engine encoding information for a micro-controller. In one embodiment, the cipher-engine 302 may encode information for communication data payloads transmitted between the computer and the RF peripheral device. As stated above, the cipher-engine 302 may be a separate device, or may be implemented by software executed by the micro-controller 301. The embodiment of the micro-controller 301 and cipher-engine 302 may represent the micro-controller 203 and cipher-engine 207 and/or the micro-controller 211 and cipher-engine 215 in FIG. 2.

As seen in FIG. 3, in one embodiment, a key register 309 (i.e., an encryption key) may be used by the cipher-engine 302 to encode/decode information. For example, the cipher-engine 302 may use the key register 309 as a pattern to encode plain text input 311 in the encryption circuit 303. In one embodiment, an XOR logic 305 may also be used to produce the coded output 307. Other encryption standards are also contemplated. For example, encryption methods such as, but not limited to Diffie-Hellman, triple data encryption standard (DES), advanced encryption standard (AES), and XOR encryption may be used.

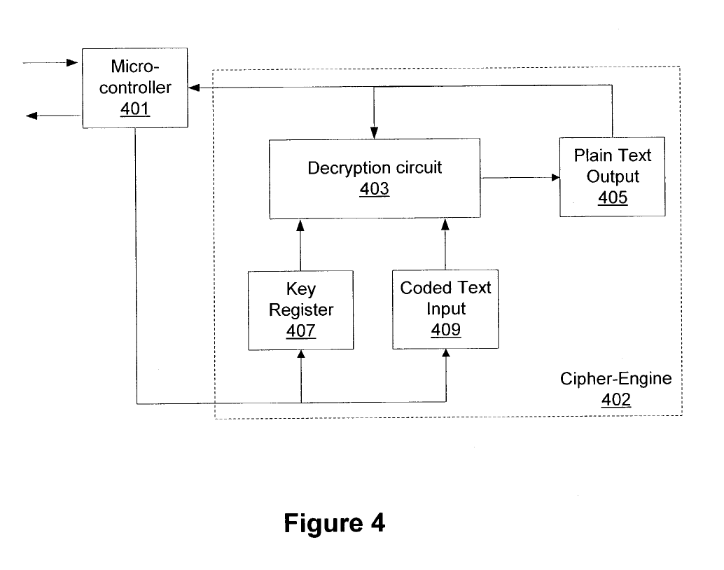

FIG. 4: Block Diagram for Decoding an RF Signal

FIG. 4 illustrates a block diagram of an embodiment of a cipher-engine decoding information for a micro-controller. A cipher-engine 402 may use a key register 407 with a decryption circuit 403 to decode coded output 409 into plain text output 405. The embodiment of the micro-controller 401 and cipher-engine 402 may represent the micro-controller 203 and cipher-engine 207 and/or the micro-controller 211 and cipher-engine 215 in FIG. 2.

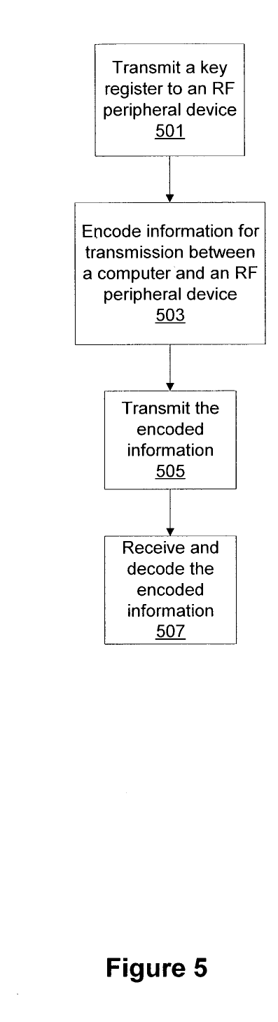

FIG. 5: Flowchart for Encoding and Decoding

FIG. 5 illustrates a flowchart of an embodiment of a method for encoding and decoding RF signals between a computer and the RF peripheral device. It should be noted that in various embodiments of the methods described below, one or more of the steps described may be performed concurrently, in a different order than shown, or may be omitted entirely. Other additional steps may also be performed as desired.

In 501, a key register may be transmitted to the RF peripheral device. In one embodiment, the computer may send a copy of the key register to the micro-controller in the RF peripheral device to be used with the cipher-engine to encode/decode information. For example, the key register may be sent to the RF peripheral device at start-up. In one embodiment, the key register may be resent to the RF peripheral device if communication with the RF peripheral device is interrupted, or in any situation in which the RF peripheral device may have lost information. In one embodiment, a new key register may also be sent to the RF peripheral device on a periodic basis to increase security. Other frequencies of sending the public key register are also contemplated. In addition, multiple key registers may be transmitted between the computer and the RF peripheral device.

In various embodiments, different types of key registers may be used by the cipher-engines to encode/decode information. For example, if a public key encryption scheme is used, one key register (i.e., a public key register) may be used by the cipher-engine in both the RF peripheral device and the computer to encode/decode information. In one embodiment, the public key register may only be made available to the RF peripheral devices that the computer trusts (e.g., the RF peripheral device may be required to transmit a password or code to the computer at start-up to insure the computer that the RF peripheral device can be trusted.) In another embodiment, the public key register may be fixed in the RF peripheral device when the RF peripheral device is manufactured. Other public key register embodiments are also contemplated.

In one embodiment, a symmetric key encryption scheme may be used in which a symmetric key register is encoded using the public key register before being exchanged between the computer and the RF peripheral device. The symmetric key register may be used by the computer and the RF peripheral device to encode/decode information to be transmitted. In one embodiment, the symmetric key register may be periodically changed, (e.g., a new symmetric key register may be encoded using the public key register and sent to the RF peripheral device). The RF peripheral device may decode the new symmetric key register and use the symmetric key register to encode/decode subsequent communication data payloads. The RF peripheral device and the computer may also store and use multiple key registers. Other encryption methods and key registers are also contemplated.

For example, encryption methods such as, but not limited to, XOR, Diffie-Hellman, triple DES, and AES encryption may be used. In one embodiment, XOR encryption may include a bitwise XOR on each byte of data to encode with a key register. Then the data can be decoded by applying XOR to each by of the coded output and the same key register. In one embodiment, a Diffie-Hellman secure key exchange. For example, a computer and an RF peripheral device may exchange public calculated values based on a private key stored on the computer and RF peripheral device (the private keys stored on each may be different). The exchanged public calculated values may be used to calculate a session key to use by each of the computer and the RF peripheral device. In one embodiment, the private keys may be periodically changed and a new session key periodically calculated. In on embodiment, triple DES may include three 64-bit keys for an overall key length of 192 bits. The 192-bit key is then divided into three subkeys (which may be padded if needed to be 64 bits each). Data may then be encoded with a first subkey, decoded with a second subkey, and encoded again with a third subkey. In one embodiment, AES may use variable block lengths and variable key lengths. For example, keys of length 128 bits, 192 bits, and 256 bits may be used to encode data blocks of 128 bits, 192 bits, and 256 bits. Any combination of these key lengths and blocks lengths may be used. Other key lengths and blocks lengths are also contemplated. For example, key lengths and block lengths may be extended by multiples of 32 bits.

In 503, the information for transmission between the RF peripheral device and the computer may be encoded. In one embodiment, the information may be encoded by a micro-controller using a cipher-engine. For example, the cipher-engine may use an encryption circuit 303 (see FIG. 3) to encode information such as, but not limited to, plain text input 311 using a key register 309. In one embodiment, the public key register scheme or the symmetric key register scheme may be used to encode/decode the information. In another embodiment, a triple data encryption standard (DES) engine may be used in a standard cipher feedback configuration where the key register is used as the initialization vector for encoding the information. In one embodiment, the information may be encoded by applying XOR to the information and the initialization vector. The result of the XOR is the encoded communication data payload to be transmitted. In one embodiment, prior encoded communication data payloads may be used as the initialization vector for the next set of information to be encoded. Other encryption or encoding schemes are also contemplated.

In 505, the encoded information may be transmitted. The information transmitted may include an encoded portion and an unencoded portion. For example, header information and other standard information in the communication data payloads may not be encoded to prevent predictable portions of the encoded information from being used to crack the key register. For example, repeated header information may be adversely used to derive the key register used to encode the information. In an alternative embodiment, all of the information may be encoded.

In one embodiment, a transmission strength of the signal containing the encoded information may be minimized. Reducing the strength of the transmission may reduce the number of other RF peripheral devices and/or computer systems receiving the transmissions to further increase security. For example, if the RF peripheral device has a fixed key assigned to the RF peripheral device, other RF peripheral devices may have the similar key assigned. These other RF peripheral devices may intercept the transmission and be able to decode the transmission. The transmission strength may be decreased to a range of minimally acceptable transmission strengths to prevent the other RF peripheral devices from intercepting the encoded information. In one embodiment, the reduction in transmission strength may increase security.

In 507, the encoded information may be received and decoded. In one embodiment, the current key register may be used by the micro-controller to decode the encoded information using the cipher-engine. Once the information is decoded, the information may be made available for use by the receiving device, i.e., the computer or the RF peripheral device.

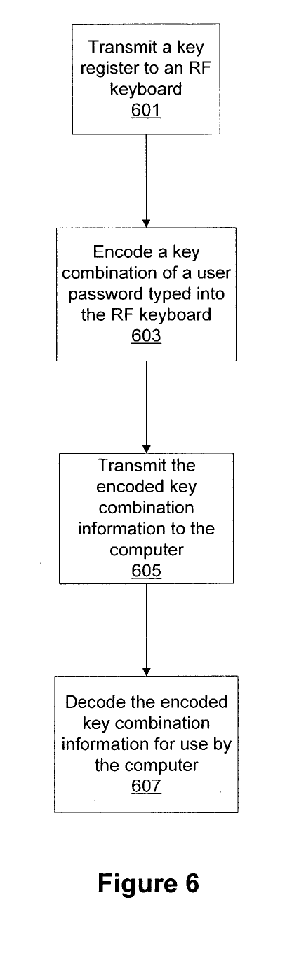

FIG. 6: Flowchart of a Method For Encoding and Decoding a Key Combination Transmitted To a Computer System

FIG. 6 is a flowchart of an embodiment of a method for encoding and decoding a key combination typed into an RF keyboard and transmitted to a computer. It should be noted that in various embodiments of the methods described below, one or more of the steps described may be performed concurrently, in a different order than shown, or may be omitted entirely. Other additional steps may also be performed as desired.

In 601, a key register may be transmitted from the computer to the RF keyboard. In one embodiment, a micro-controller in the computer, or a peripheral base station coupled to the computer, may transmit a key register to the RF keyboard for use in encoding/decoding information transmitted between the computer and the RF keyboard. For example, in one embodiment, a processor in the computer may execute instructions to transmit the key register to the RF keyboard. In one embodiment, a bulk CMOS transceiver may receive the key register to be used by the micro-controller in the RF keyboard. In one embodiment, the key register may not be sent to the RF keyboard. For example, the RF keyboard may have a fixed key register. Other encryption methods are also contemplated.

In 603, a key combination of a user password typed into the RF keyboard may be encoded. For example, a user may type a key combination for the user's password using the RF keyboard. In one embodiment, the micro-controller, or cipher-engine coupled to the micro-controller, in the RF keyboard may encode the key combination for the user's password using the key register previously received by the RF keyboard. Other information from the RF keyboard may also be encoded.

In 605, the encoded key combination information may be transmitted to the computer. In one embodiment, the encoded key combination representing the user's password may be transmitted by the bulk CMOS transceiver on the RF keyboard in a wireless fashion and received by the bulk CMOS transceiver on the computer (or a peripheral base station). Other transmitters and receivers are also contemplated.

In 607, the encoded key combination information may be decoded by the micro-controller in the computer (or in the peripheral base station coupled to the computer) using the key register. After being decoded, the key combination information may be used by the computer. In one embodiment, the encoded information may be transmitted from the RF peripheral device and remain encoded until delivered to a remote device or computer over a wired or second wireless network. In one embodiment, the encoded information may be encoded again using a different key register at the peripheral base station. Other decoding methods are also contemplated.

Various embodiments may further include receiving or storing instructions and/or information implemented in accordance with the foregoing description upon a carrier medium. Suitable carrier media may include storage media or memory media such as magnetic or optical media, e.g., disk or CD-ROM, random access memory or other memory, as well as transmission media or RF signals such as electrical, electromagnetic, or digital RF signals, conveyed via a communication medium such as a network and/or a wireless link.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A computer system, comprising:
a processor;
a first radio frequency transmitter/receiver (RFTR);
an RF peripheral device comprising a second RFTR configured to transmit encoded radio frequency (RF) signals, wherein the first RFTR and the second RFTR are operable to communicate in a wireless fashion; and
a first memory coupled to the processor and configured to store program instructions executable to decode the encoded RF signals from the RF peripheral device.

2. The computer system of claim 1, further comprising:
an cipher engine device for encoding or decoding information.

3. The computer system of claim 2,
wherein the cipher-engine is a triple data encryption standard engine.

4. The computer system of claim 1,
wherein the RF peripheral device comprises a second memory for storing a key register.

5. The computer system of claim 1,
wherein the first memory stores program instructions further executable to transmit a key register.

6. The computer system of claim 1,
wherein the RF peripheral device is further configured to transmit the RF signal comprised of an unencoded portion and an encoded portion.

7. The computer system of claim 1,
wherein the program instructions are further configured to implement a public key encryption scheme.

8. The computer system of claim 1,
wherein the program instructions are further configured to implement a symmetric key encryption scheme.

9. The computer system of claim 1,
wherein the processor and the first memory are comprised in a peripheral base station.

10. The computer system of claim 1,
wherein the first RFTR is comprised in the peripheral base station and information received by the peripheral base station is encoded by the peripheral base station before the information is further transmitted.

11. The computer system of claim 10,
wherein the information is further transmitted to another computer system.

12. The computer system of claim 10,
wherein the information is further transmitted to a second network.

13. The computer system of claim 1,
wherein the RF peripheral device comprises a sensor, a switch, a micro-controller, a cipher-engine and a bulk CMOS transceiver.

14. The computer system of claim 1,
wherein the computer system further comprises a USB interface, a micro-controller, a cipher-engine, and a bulk CMOS transceiver.

15. The computer system of claim 1,
wherein the first memory stores program instructions further executable to use a standard cipher feedback configuration using an key register as an initialization vector for an encryption block.

16. The computer system of claim 1,
wherein the first memory stores program instructions further executable to implement an encryption method selected from a group consisting of Diffie-Hellman, triple data encryption standard (DES), advanced encryption standard (AES), and XOR encryption.

17. The computer system of claim 1,
wherein the RF peripheral device is an RF computer mouse, an RF keyboard, an RF camera, an RF joystick, an RF gamepad, an RF touchscreen, or an RF microphone.

18. The computer system of claim 1,
wherein the RF peripheral device is an RF display, an RF printer, or an RF speaker.

19. The computer system of claim 1,
wherein the RF peripheral device and the first RFTR encode information transmitted between the RF peripheral device and the first RFTR using key register exchanges using bi-directional radio wave communication.

20. The computer system of claim 1,
wherein the encoded information is transmitted to the RF peripheral base station at a transmission strength approximately in a range of minimally acceptable transmission strengths.

21. The computer system of claim 1,
wherein the encoded information is transmitted from the second RFTR to the first RFTR at a transmission strength approximately in a range of minimally acceptable transmission strengths.

22. A method comprising:
an RF peripheral device encoding RF peripheral device information;
transmitting the encoded RF peripheral device information to a computer; and
decoding the encoded RF peripheral device information.

23. The method of claim 22, further comprising:
transmitting a key register to the RF peripheral device.

24. The method of claim 23,
wherein a new key register is sent to the RF peripheral device at re-initialization.

25. The method of claim 22, further comprising implementing a public key encryption scheme.

26. The method of claim 22, further comprising implementing a symmetric key encryption scheme.

27. The method of claim 22, wherein the encoding is implemented using an encryption method selected from a group consisting of Diffie-Hellman, triple data encryption standard (DES), advanced encryption standard (AES), and XOR encryption.

28. The method of claim 22, further comprising:
receiving user input indicating a password;
wherein the RF peripheral device encoding RF peripheral device information includes encoding the password.

29. The method of claim 22, further comprising:
transmitting encoded information from the computer to the RF peripheral device.

30. The method of claim 29,
wherein transmitting encoded information from the computer to the RF peripheral device further includes transmitting the encoded information at a transmission strength approximately in a range of minimally acceptable transmission strengths.

31. The method of claim 22,
wherein transmitting encoded information from the RF peripheral device to the computer further includes transmitting the encoded information at a transmission strength approximately in a range of minimally acceptable transmission strengths.

32. The method of claim 22, further comprising:
transmitting encoded information received from the RF peripheral device to a second network before decoding the encoded information.

33. The method of claim 22,
wherein the second network is a wireless network.

34. The method of claim 22,
wherein the RF peripheral device is an RF computer mouse, an RF keyboard, an RF camera, an RF joystick, an RF gamepad, an RF touchscreen, or an RF microphone.

35. The method of claim 22,
wherein the RF peripheral device is an RF speaker, an RF display, or an RF printer.

36. The method of claim 22,
wherein the computer is a personal computer, a tablet style computer, or a laptop.

37. A system comprising:
means for encoding RF peripheral device information at an RF peripheral device;
means for transmitting the encoded RF peripheral device information to a computer; and
means for decrypting the encoded RF peripheral device information.

38. A carrier medium comprising program instructions, wherein the program instructions are computer executable to:
encode RF peripheral device information at an RF peripheral device;
transmit the encoded RF peripheral device information to a computer; and
decrypt the encoded RF peripheral device information.
